(19) United States
(12) Patent Application Publication
(10) Pub. No.: US 2012/0313936 A1
(43) Pub. Date: Dec. 13, 2012

(54) STEREOSCOPIC DISPLAY SYSTEM AND STEREOSCOPIC GLASSES

(75) Inventor: Yoshifumi MATSUMOTO, Osaka (JP)

(73) Assignee: Panasonic Corporation, Osaka (JP)

(21) Appl. No.: 13/585,202

(22) Filed: Aug. 14, 2012

Related U.S. Application Data
(63) Continuation of application No. PCT/JP2011/000891, filed on Feb. 17, 2010.

(30) Foreign Application Priority Data
Feb. 17, 2010 (JP) 2010-032490

(51) Int. Cl. G06T 15/00

(52) U.S. Cl. 345/419

(57) ABSTRACT

A stereoscopic display system includes an image display unit which displays a left eye image and a right eye image for stereoscopic viewing, a pair of stereoscopic glasses worn by a viewer for viewing the images, and a tilt measurement unit which determines a tilt of a line connecting both eyes of the viewer with respect to a reference direction. The pair of stereoscopic glasses includes an optical axis change unit which transmits light which should enter one of the eyes of the viewer, and changes at least one of directions of optical axes of the optical axis change unit, and a control unit which changes at least one of the directions of the optical axes based on the tilt determined by the tilt measurement unit so as to reduce an effect of the tilt of the line on how the images appear to the viewer.

### CROSS-REFERENCE TO RELATED APPLICATION

This is a continuation of PCT International Application PCT/JP2011/000891 filed on Feb. 17, 2011, which claims priority to Japanese Patent Application No. 2010-032490 filed on Feb. 17, 2010. The disclosures of these applications including the specifications, the drawings, and the claims are hereby incorporated by reference in its entirety.

### BACKGROUND

The present disclosure relates to stereoscopic display systems and stereoscopic glasses for providing viewers with stereoscopic vision.

Humans can see a stereoscopic image of an object with the use of parallax due to a distance between both eyes. Stereoscopic display refers to a technique for providing a viewer with stereoscopic vision by presenting two slightly different images separately to the left eye and the right eye of the viewer. Well known techniques of stereoscopic display for providing stereoscopic vision include stereoscopic glass method using a polarizing plate or a liquid crystal (LC) shutter, a lenticular lens method requiring no glasses, etc.

Japanese Patent Publication No. 2001-296501 (Patent Document 1) describes an example of stereoscopic display controller. A viewer can successfully perceive a stereoscopic image unless the line connecting both eyes of the viewer is out of parallel with the horizontal direction.

### SUMMARY

If the viewer tilts his or her head with respect to the screen on which the images are displayed, the line connecting a left eye image with a right eye image on the screen is no longer parallel to the line connecting both eyes of the viewer. If the viewer actually sees an object, a condition where the two lines are not parallel to each other cannot occur, and thus a pair of the left eye image and the right eye image under such a condition creates difficulties in perceiving a stereoscopic image, thereby causing strain in the viewer. Accordingly, if the viewer tilts his or her head greatly, the device of Patent Document 1 stops displaying the stereoscopic image, and then displays a normal (non-stereoscopic) image, thereby prevents the strain of the viewer. However, viewing a stereoscopic image requires the viewer to avoid tilting his or her head, which does not allow the viewer to view a stereoscopic image in a comfortable position.

It is an object of the present disclosure to provide the viewer with a stereoscopic image while reducing strain of the viewer even if the viewer tilts his or her head.

A stereoscopic display system according to an embodiment of the present disclosure includes an image display unit configured to display a left eye image and a right eye image for stereoscopic viewing, a pair of stereoscopic glasses configured to be worn by a viewer for stereoscopically viewing the left eye image and the right eye image displayed on the image display unit, and a tilt measurement unit configured to determine a tilt of a line connecting both eyes of the viewer with respect to a reference direction. The pair of stereoscopic glasses includes an optical axis change unit configured to transmit light which should enter one of the eyes of the viewer, and to change at least one of directions of an optical axis on an incident side and of an optical axis on a transmission side of the optical axis change unit, and a control unit configured to change at least one of the directions of the optical axis on the incident side and of the optical axis on the transmission side of the optical axis change unit based on the tilt determined by the tilt measurement unit so as to reduce an effect of the tilt of the line on how the images appear to the viewer.

Another stereoscopic display system according to the embodiment of the present disclosure includes an image display unit, and a tilt measurement unit configured to determine a tilt of a line connecting both eyes of the viewer with respect to a reference direction. The image display unit includes an image generator configured to generate a left eye image and a right eye image for stereoscopic viewing, an image processor configured to perform a process of moving at least one of the left eye image or the right eye image based on the tilt determined by the tilt measurement unit so as to reduce an effect of the tilt of the line on how the images appear to the viewer, and a display unit configured to display the left eye image and the right eye image at least one of which is processed by the image processor.

A pair of stereoscopic glasses according to an embodiment of the present disclosure is a pair of stereoscopic glasses worn by a viewer for stereoscopically viewing images displayed on an image display unit, and includes a tilt measurement unit configured to determine a tilt of the pair of stereoscopic glasses with respect to a reference direction, an optical axis change unit configured to transmit light which should enter one of the eyes of the viewer, and to change at least one of directions of an optical axis on an incident side and of an optical axis on a transmission side of the optical axis change unit, and a control unit configured to change at least one of the directions of the optical axis on the incident side and of the optical axis on the transmission side of the optical axis change unit based on the tilt determined by the tilt measurement unit so as to reduce an effect of a tilt of a line connecting both eyes of the viewer on how the images appear to the viewer.

According to the embodiments of the present disclosure, the viewer can successfully perceive a stereoscopic image even if the viewer tilts his or her head, thereby reducing strain of the viewer in viewing the stereoscopic image. Since there is no need to maintain the head in an upright position, the viewer can view a stereoscopic image in a comfortable position.

### BRIEF DESCRIPTION OF THE DRAWINGS

FIG. 1 is a schematic diagram illustrating an example configuration of a stereoscopic display system according to an embodiment of the present invention.

FIG. 2 is a block diagram illustrating an example configuration of the stereoscopic glasses of FIG. 1.

FIG. 3 is a block diagram illustrating an example configuration of the display unit of FIG. 1.

FIG. 4 is a diagram illustrating an example configuration of one optical element of FIGS. 1 and 2.

FIG. 5A is a cross-sectional view illustrating the optical axis change unit of FIG. 4 in a normal condition. FIG. 5B is a cross-sectional view illustrating the optical axis change unit of FIG. 4 in a transformed condition.

FIG. 6 is an illustrative diagram of an example of how images appear to the viewer when the viewer has not tilted his or her head.

FIG. 7 is an illustrative diagram of an example of how images appear to the viewer when the viewer has tilted his or her head.

FIG. 8 is an illustrative diagram of apparent movements of images produced by the stereoscopic glasses of FIG. 2.

FIG. 9 is a schematic diagram illustrating another example configuration of a stereoscopic display system according to the embodiment of the present invention.

FIG. 10 is a block diagram illustrating an example configuration of the stereoscopic glasses of FIG. 9.

FIG. 11 is a block diagram illustrating an example configuration of the stereoscopic display unit of FIG. 9.

FIG. 12A is an illustrative diagram of an example of an image generated by the image generator of FIG. 11. FIG. 12B is an illustrative diagram of an example of the image with the size reduced by the image processor of FIG. 11. FIG. 12C is an illustrative diagram of an example of the image subjected to translational movement by the image processor. FIG. 12D is an illustrative diagram of an example of the image rotated by the image processor.

FIG. 13 is an illustrative diagram of an example of movement of images performed when the viewer has tilted his or her head.

FIG. 14 is an illustrative diagram of apparent movement of the images in the case of FIG. 13.

FIG. 15 is an illustrative diagram of another example of movement of images performed when the viewer has tilted his or her head.

FIG. 16 is an illustrative diagram of apparent movement of the images in the case of FIG. 15.

FIG. 17 is a block diagram illustrating a configuration of a variation of the stereoscopic display unit of FIG. 11.

FIG. 18 is an illustrative diagram of a case where a left eye image and a right eye image are displayed on the screen of the display unit, with parts thereof superimposed over each other.

### DETAILED DESCRIPTION

Example embodiments of the present invention will be described below with reference to the drawings, in which reference numbers having the same last two digits indicate components corresponding to one another, which are the same or similar components.

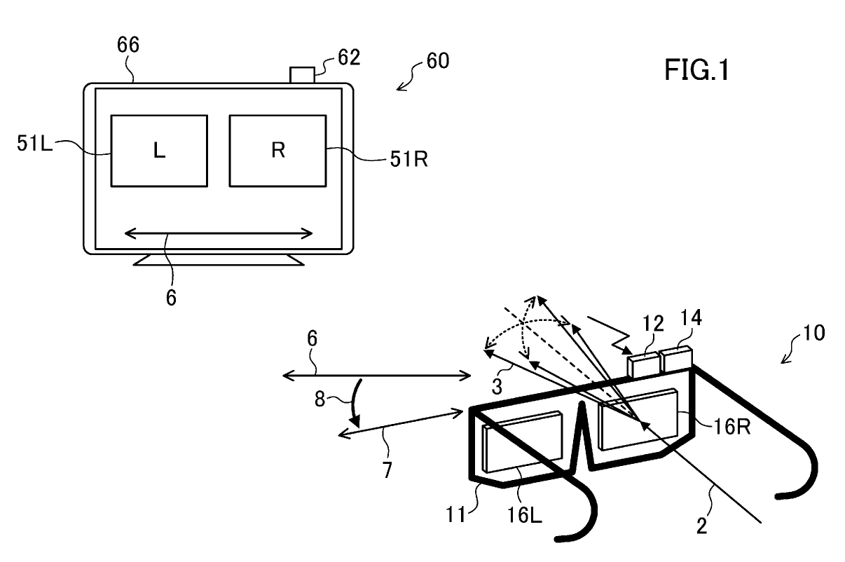

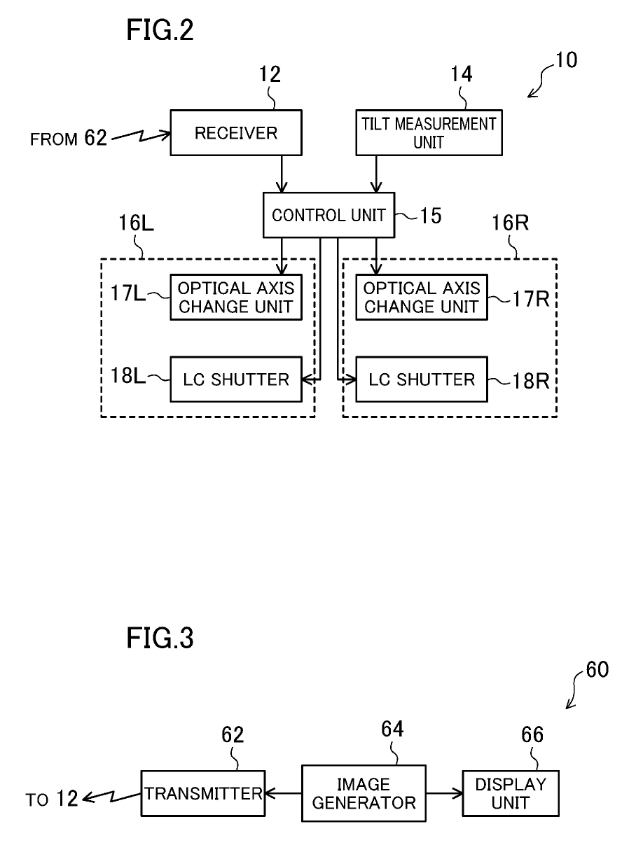

FIG.1 is a schematic diagram illustrating an example configuration of a stereoscopic display system according to an embodiment of the present invention. The stereoscopic display system of FIG. 1 includes a pair of stereoscopic glasses 10 and a stereoscopic display unit 60. The pair of stereoscopic glasses 10 is worn by a viewer for stereoscopically viewing the images displayed on the stereoscopic display unit 60. FIG. 2 is a block diagram illustrating an example configuration of the stereoscopic glasses 10 of FIG. 1. FIG. 3 is a block diagram illustrating an example configuration of the stereoscopic display unit 60 of FIG. 1.

The pair of stereoscopic glasses 10 includes a frame 11, a receiver 12, a tilt measurement unit 14, a control unit 15, a left eye optical element 16L, and a right eye optical element 16R. The optical element 16L includes an optical axis change unit 17L and an LC shutter 18L. The optical element 16R includes an optical axis change unit 17R and an LC shutter 18R. The optical axis change unit 17L and the LC shutter 18L transmit light which should enter the left eye of the viewer, and the optical axis change unit 17R and the LC shutter 18R transmit light which should enter the right eye of the viewer. Each of the optical axis change units 17L and 17R can change the directions of the optical axis on the incident side and of the optical axis on the transmission side.

The stereoscopic display unit 60 includes a transmitter 62, an image generator 64, and a display unit 66. The image generator 64 generates a left eye image 51L and a right eye image 51R for providing a stereoscopic image, and outputs the images 51L and 51R to the display unit 66. The image generator 64 alternately displays the images 51L and 51R onto the display unit 66, and outputs a switching signal which indicates the timings to display the images 51L and 51R, to the transmitter 62. The transmitter 62 transmits this switching signal to the receiver 12 of the stereoscopic glasses 10 by means of infrared light, a radio wave, etc. The images 51L and 51R may be video or still images.

The left eye image 51L and the right eye image 51R are displayed on the entire screen or on a portion of the screen of the display unit 66. Controlling the horizontal distance between the images 51L and 51R allows the lines of sight of both eyes of the viewer to be controlled. Note that, for purposes of better understanding of the orientation of each image, FIG. 1 and other figures which illustrate the screens described below show square frames around the regions in which the left eye image 51L and the right eye image 51R are respectively displayed. The frames are not actually displayed.

The receiver 12 receives the switching signal from the transmitter 62, and outputs the switching signal to the control unit 15. The control unit 15 alternately opens and closes the LC shutters 18L and 18R in synchronism with the switching signal, thereby allows the left eye image 51 L and the right eye image 51R to respectively enter the left eye and the right eye of the viewer who wears the stereoscopic glasses 10.

The tilt measurement unit 14 is, for example, fixed to the frame 11. The tilt measurement unit 14 determines the tilt 8 of a line 7 connecting both eyes of the viewer with respect to a reference direction such as the horizontal direction 6, and outputs the resulting determined value to the control unit 15. The tilt 8 is the same as the tilt of the pair of stereoscopic glasses 10, and thus as the tilt of the head of the viewer, with respect to the reference direction. For example, the tilt measurement unit 14 has an acceleration sensor, and calculates the tilt of the stereoscopic glasses 10 with respect to the reference direction (e.g., the horizontal direction 6), that is, the tilt 8, based on the acceleration sensed by the acceleration sensor. The tilt 8 can be determined by determining the tilt of the line 7 (the tilt of the head of the viewer) with respect to the display unit 66 by the tilt measurement unit 14. Accordingly, the reference direction may be, for example, the direction of one edge of the screen of the display unit 66.

When the viewer tilts his or her head, the entire screen including the images 51L and 51R appears to the viewer to rotate. The control unit 15 controls at least one of the optical axis change units 17L and 17R to change at least one of the directions of the optical axis on the incident side and of the optical axis on the transmission side based on the tilt determined by the tilt measurement unit 14, so as to reduce the effect of the tilt 8 of the line connecting both eyes of the viewer on how the images appear to the viewer, in other words, so as to reduce the effect of the rotation of the entire screen as viewed by such a viewer. For example, as shown in FIG. 1, the line of sight 2 of the viewer is changed to, for example, the line of sight 3 by the optical axis change unit 17R.

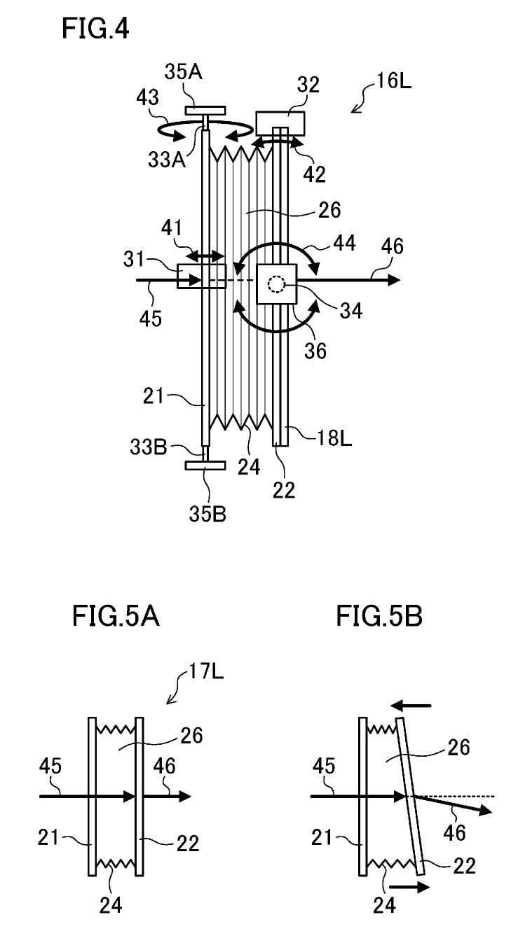

FIG. 4 is a diagram illustrating an example configuration of the optical element 16L of FIGS. 1 and 2. The optical element 16R has a similar configuration. In the optical element 16L of FIG. 4, the parts other than the LC shutter 18L constitute the optical axis change unit 17L. The optical axis change unit 17L is an active prism. The optical axis change unit 17L includes transparent plates 21 and 22, bellows 24, transparent liquid 26, actuators 31 and 32, rotating shafts 33A, 33B, and 34, and bearings 35A, 35B, and 36.

The transparent plates 21 and 22 are connected together by the cylindrical bellows 24. The space sealed by the transparent plates 21 and 22 and the bellows 24 is filled with the transparent liquid 26. The refractive index of the transparent liquid 26 is close to that of the transparent plates 21 and 22. The transparent plates 21 and 22 are respectively coupled with the actuators 31 and 32.

The transparent plate 21 is coupled with the rotating shafts 33A and 33B. The transparent plate 21 rotates around the rotating shafts 33A and 33B. The line connecting the rotating shafts 33A and 33B passes near the center of the transparent plate 21. The transparent plate 22 is coupled with the rotating shaft 34, which is perpendicular to the rotating shafts 33A and 33B. The transparent plate 22 rotates around the rotating shaft 34. When the actuator 31 moves an edge of the transparent plate 21 along the directions of the arrow 41, the transparent plate 21 rotates around the rotating shafts 33A and 33B in the directions of the arrow 43. When the actuator 32 moves an edge of the transparent plate 22 along the directions of the arrow 42, the transparent plate 22 rotates around the rotating shaft 34 in the directions of the arrow 44.

FIG. 5A is a cross-sectional view illustrating the optical axis change unit 17L of FIG. 4 in a normal condition. FIG. 5B is a cross-sectional view illustrating the optical axis change unit 17L of FIG. 4 in a transformed condition. In a normal condition shown in FIG.

5A, the transparent plates 21 and 22 are nearly parallel to each other, and therefore the light incident on the transparent plate 21 exits from the transparent plate 22 without changing its direction. That is, the directions of the optical axis 45 on the side of the transparent plate 21 and of the optical axis 46 on the side of the transparent plate 22 are the same.

For example, when the actuator 32 moves the transparent plate 22, the optical axis change unit 17L changes to a transformed condition as shown in FIG. 5B. In this condition, the transparent plates 21 and 22 are no longer parallel to each other, and therefore the light incident on the transparent plate 21 exits from the transparent plate 22 in a direction different from the incident direction. That is, the direction of the optical axis 46 on the side of the transparent plate 22 is changed depending on the movement of the actuator 32.

Although FIG. 4 shows a configuration in which a line resulting from extension of the rotating shafts 33A and 33B passes near the center of the transparent plate 21, the rotating shafts 33A and 33B may be positioned so that the above-mentioned line is more distant from the actuator 31. For example, the rotating shafts 33A and 33B may be positioned so that the line resulting from extension thereof passes the point which is symmetric to the position of the actuator 31 with respect to the center of the transparent plate 21.

Two actuators may be attached to the periphery of the transparent plate 21 respectively at two points symmetric to each other with respect to the center of the transparent plate 21. In such a case, the two actuators are adapted to move in opposite directions, which allows the rotating shafts to be omitted.

The actuator 31 may be positioned on the rotating shaft 33A so as to allow the actuator 31 to rotate the rotating shaft 33A, and thereby to rotate the transparent plate 21. The various modifications as described above may also be applied to the transparent plate 22.

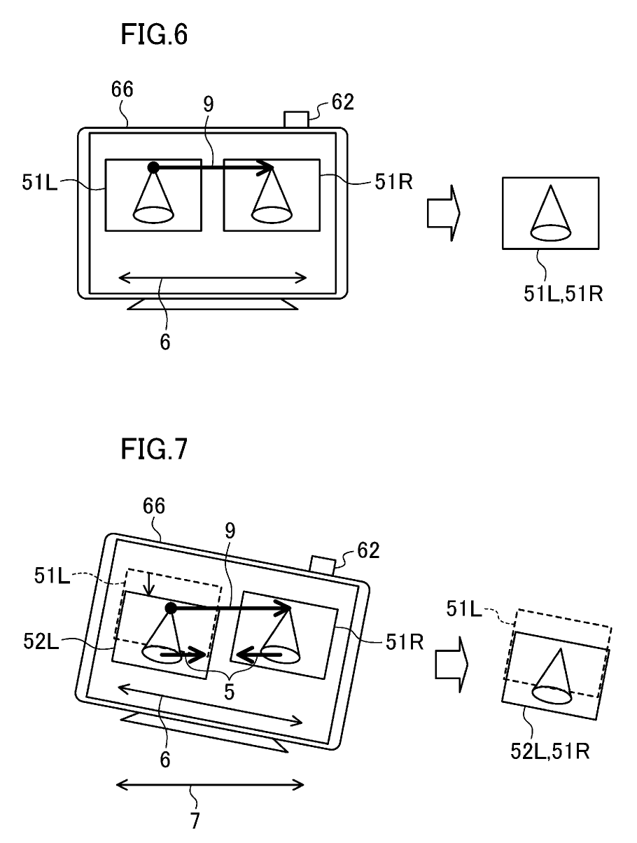

FIG. 6 is an illustrative diagram of an example of how images appear to the viewer when the viewer has not tilted his or her head. In this case, the direction of the vector 9 from the left eye image 51L to the right eye image 51R is parallel to the direction of the line connecting both eyes of the viewer. Thus, the viewer can easily superimpose the images 51L and 51R to perceive a stereoscopic image.

FIG. 7 is an illustrative diagram of an example of how images appear to the viewer when the viewer has tilted his or her head. In FIG. 7, the head of the viewer rotates counterclockwise with respect to the horizontal direction as viewed from the viewer. In this case, the entire screen of the display unit 66 appears to the viewer to rotate clockwise. The direction of the vector from the image 51L to the image 51R is not parallel to the direction 7 of the line connecting both eyes of the viewer. Since the direction 5 of eye movement of the viewer for viewing a stereoscopic image is parallel to the direction 7, the viewer has difficulty perceiving a stereoscopic image.

Thus, the control unit 15 of FIG. 2 controls the optical axis change unit 17L so that the optical axis on the side of the display unit 66 (incident side) of the optical axis change unit 17L extends upward with respect to the optical axis on the viewer side (transmission side) as viewed from the viewer, based on the determined tilt. In addition, the control unit 15 controls the optical axis change unit 17R so that the optical axis on the side of the display unit 66 of the optical axis change unit 17R extends downward with respect to the optical axis on the viewer side as viewed from the viewer, based on the determined tilt. Such an operation causes the line of sight of the left eye of the viewer to move upward, and the line of sight of the right eye of the viewer to move downward, thereby causing the image 51L to appear to the viewer to move downward to become the image 52L, and the image 51R to appear to the viewer to move upward. (For simplicity, FIG. 7 omits to show the movement of the image 51R.) In this operation, the control unit 15 provides control so that the direction of the vector 9 from the image 52L to the image 51R will be close to (ideally, will be parallel to) the direction 7 of the line connecting both eyes of the viewer. Since the direction of the vector 9 becomes close to the direction 7, the viewer can superimpose the images 52L and 51R, and perceive a stereoscopic image without uncomfortable feeling.

According to the stereoscopic glasses 10 of FIG. 2, as described above, even if the viewer tilts his or her head with respect to the screen which displays images for providing a stereoscopic image, the directions of the optical axes of the optical axis change units 17L and 17R are changed based on the tilt determined by the tilt measurement unit 14, and thus the apparent positions of the images are corrected accordingly, thereby reducing the effect of tilting the head of the viewer on how the images appear. Therefore, the viewer can successfully perceive a stereoscopic image while reducing strain. Since there is no need to maintain the head in an upright position, the viewer can view a stereoscopic image in a comfortable position.

Also in cases where more than one viewer sees a same stereoscopic image at the same time, each pair of the stereoscopic glasses corrects the apparent positions of the images based on the tilt of the head of the viewer who wears that pair of the stereoscopic glasses. Thus, the stereoscopic display system of FIG. 1 is suitable for use in living rooms of houses and in theaters, where one stereoscopic image is viewed by more than one viewer.

The foregoing description has been provided in which the apparent positions of the images are moved only in the vertical direction as viewed from the viewer. In such a case, the effect of rotation of the screen as viewed from the viewer is not completely canceled out in a strict sense. However, due to the human visual characteristics, displacement of images in the vertical direction has a more significant effect on the perception of a stereoscopic image than rotation of images, and thus canceling out the displacement in the vertical direction alone facilitates the perception of a stereoscopic image.

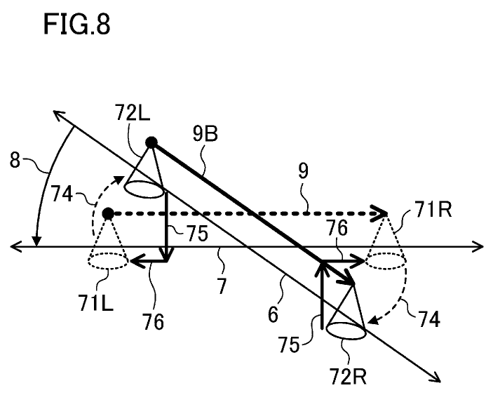

FIG. 8 is an illustrative diagram of apparent movements of images produced by the pair of stereoscopic glasses 10 of FIG. 2. When the viewer tilts his or her head, the images viewed from the viewer rotate, for example, as shown by the arrows 74. In this case, an object 71L in the left eye image 51L appears to move to the position of the object 72L, and an object 71R in the right eye image 51R appears to move to the position of the object 72R. The vector 9 from the object 71L to the object 71R rotates to become the vector 9B. Moving the apparent positions of the images in the vertical direction as viewed from the viewer corresponds to moving the objects 72L and 72R, for example, along the arrows 75 of FIG. 8.

Here, the apparent positions of the images may further be moved in the horizontal direction as viewed from the viewer. Such movement corresponds to moving the objects 72L and 72R, for example, along the arrows 76 of FIG. 8. In order to achieve such movement, the control unit 15 of FIG. 2 further controls the optical axis change units 17L and 17R so that the optical axis on the side of the display unit 66 of the optical axis change unit 17L extends to the right with respect to the optical axis on the viewer side as viewed from the viewer, and the optical axis on the side of the display unit 66 of the optical axis change unit 17R extends to the left with respect to the optical axis on the viewer side as viewed from the viewer. In this operation, the control unit 15 provides control so that the images 51L and 51R move by the distances corresponding to the arrows 76 based on the determined tilt. Such an operation allows the objects 72L and 72R to be returned to the original positions, that is, the positions of the objects 71L and 71R, thereby further reducing the effect of rotation of the images as viewed from the viewer, and allowing the viewer to perceive a stereoscopic image more naturally.

Although the foregoing description has been provided in which the control unit 15 controls both the optical axis change units 17L and 17R, the control unit 15 may control only one of the optical axis change units 17L and 17R. The stereoscopic glasses 10 may include only one of the optical axis change units 17L and 17R.

Although the foregoing description has been provided in terms of a stereoscopic display system in which the stereoscopic glasses 10 includes the LC shutters 18L and 18R, and the stereoscopic display unit 60 displays the left eye image and the right eye image alternately in a time-division manner, a stereoscopic display system having another mechanism can also use a pair of stereoscopic glasses having optical axis change units 17L and 17R such as the stereoscopic glasses 10. For example, a stereoscopic display system which uses a polarizing plate for separation of the left eye image and the right eye image may use a pair of stereoscopic glasses which has replaced the LC shutters 18L and 18R with polarizing plates in the stereoscopic glasses 10. A stereoscopic display system which uses a lenticular system etc. to display a stereoscopic image without need for glasses by nature may use a pair of stereoscopic glasses which is equivalent to the pair of stereoscopic glasses 10 without the LC shutters 18L and 18R.

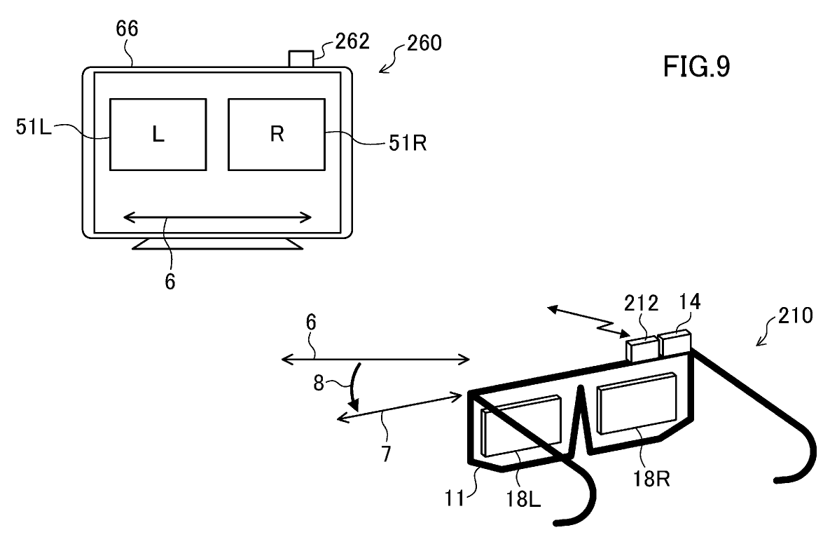

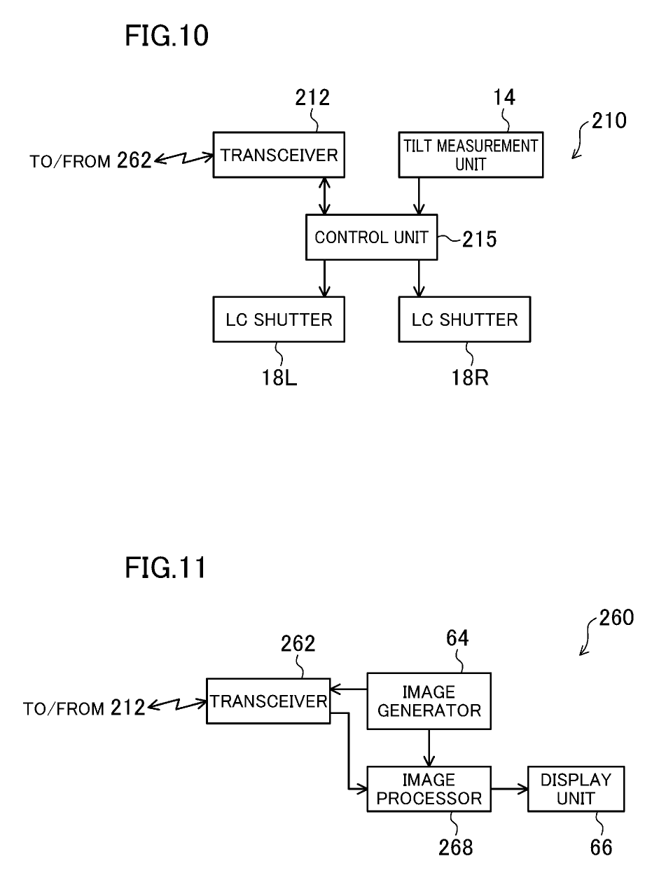

FIG. 9 is a schematic diagram illustrating another example configuration of a stereoscopic display system according to the embodiment of the present invention. The stereoscopic display system of FIG. 9 includes a pair of stereoscopic glasses 210 and a stereoscopic display unit 260. The pair of stereoscopic glasses 210 is worn by a viewer for stereoscopically viewing the images displayed on the stereoscopic display unit 260. FIG. 10 is a block diagram illustrating an example configuration of the stereoscopic glasses 210 of FIG. 9. FIG. 11 is a block diagram illustrating an example configuration of the stereoscopic display unit 260 of FIG. 9.

The pair of stereoscopic glasses 210 includes a frame 11, a tilt measurement unit 14, a transceiver 212, a control unit 215, a left eye LC shutter 18L, and a right eye LC shutter 18R. The stereoscopic display unit 260 includes a transceiver 262, an image generator 64, a display unit 66, and an image processor 268. The image generator 64 generates a left eye image 51L and a right eye image 51R for providing a stereoscopic image, and outputs the images 51L and 51R to the image processor 268. The image generator 64 outputs a switching signal which indicates the timings to alternately display the images 51L and 51R, to the transceiver 262. The transceiver 262 transmits this switching signal to the transceiver 212 of FIG. 10 by means of infrared light, a radio wave, etc.

The transceiver 212 receives the switching signal from the transceiver 262, and outputs the switching signal to the control unit 215. The LC shutters 18L and 18R, and control thereof provided by the control unit 215, are similar to those of the stereoscopic glasses 10 of FIG. 2.

The tilt measurement unit 14 is, for example, fixed to the frame 11. As with the case of FIG. 2, the tilt measurement unit 14 determines the tilt 8 of a line 7 connecting both eyes of the viewer with respect to a reference direction such as the horizontal direction 6, that is, the tilt 8 of the stereoscopic glasses 210 with respect to the reference direction, and outputs the resulting determined value to the control unit 215. The control unit 215 outputs the value of the tilt 8 determined by the tilt measurement unit 14 to the transceiver 212. The transceiver 212 is, for example, fixed to the frame 11, and transmits the value of the tilt 8 to the transceiver 262 of FIG. 11 by means of infrared light, a radio wave, etc.

The transceiver 262 receives the value of the tilt 8, and outputs the value to the image processor 268. The image processor 268 performs a process of moving on the screen at least one of the left eye image 51L or the right eye image 51R based on the value of the tilt received so as to reduce the effect of the tilt of the line connecting both eyes of the viewer on how the images appear to the viewer, in other words, so as to reduce the effect of the rotation of the entire screen as viewed by the viewer, and then outputs the result to the display unit 66. Here, the image processor 268 provides translational movement (movement without rotation) to at least one of the images 51L and 51R. The display unit 66 displays the images 51L and 51R which have been processed by, or otherwise simply transferred through, the image processor 268.

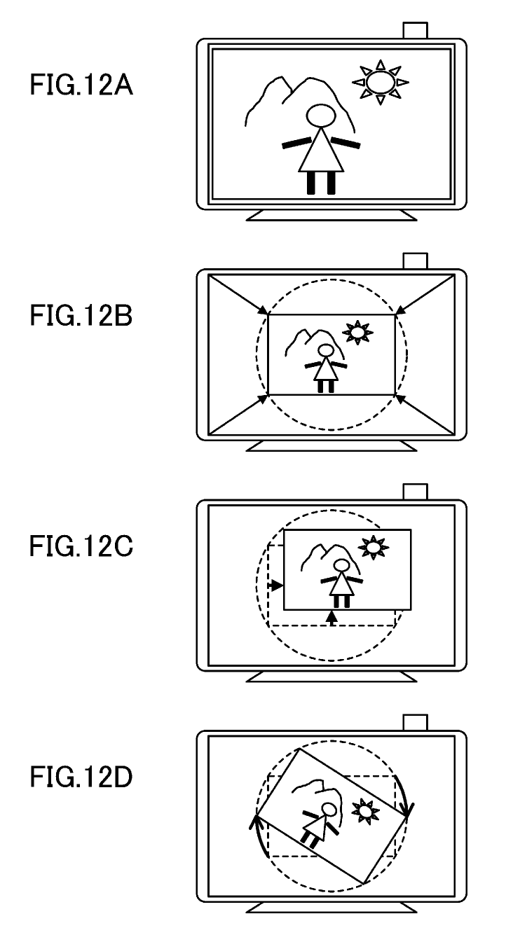

FIG. 12A is an illustrative diagram of an example of an image generated by the image generator 64 of FIG. 11. FIG. 12B is an illustrative diagram of an example of the image with the size reduced by the image processor 268 of FIG. 11. FIG. 12C is an illustrative diagram of an example of the image subjected to translational movement by the image processor 268. FIG. 12D is an illustrative diagram of an example of the image rotated by the image processor 268.

The image processor 268 includes a graphic processor and a frame memory. The image processor 268 reduces the size of the image of FIG. 12A generated by the image generator 64 as shown in FIG. 12B so that the translational and/or rotational movement will not cause the image to exceed the screen boundary. The part other than the reduced-size image is, for example, displayed in black. The image processor 268 provides translational movement to the image of FIG. 12B as shown in FIG. 12C, and/or rotates the image of FIG. 12B as shown in FIG. 12D, as appropriate. Translational movement may be performed by moving the position of the image in the frame memory, or by changing the relationship between the timings of the horizontal and the vertical synchronization signals of the display unit 66 and the timing of the image signal output from the image processor 268 to the display unit 66.

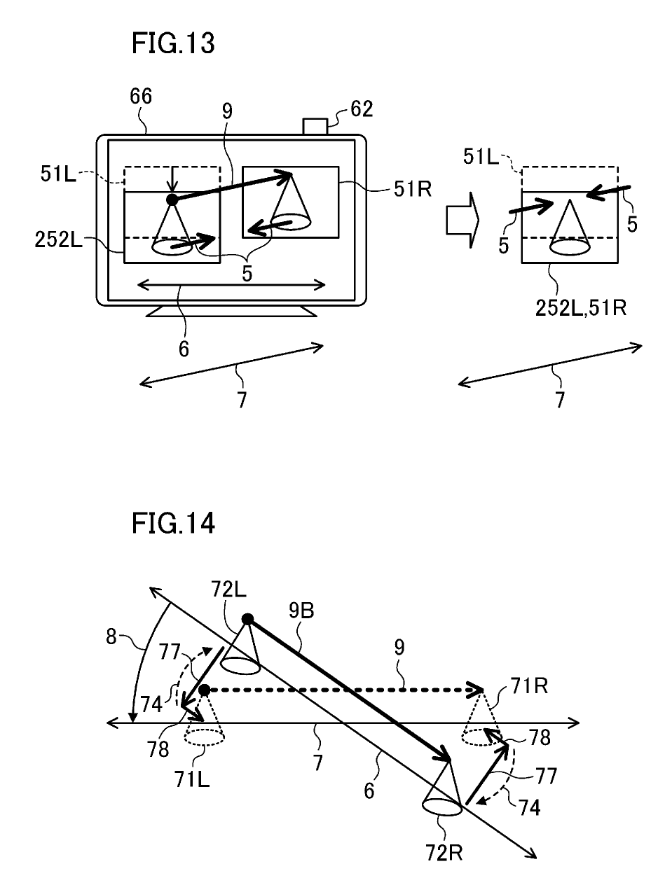

FIG. 13 is an illustrative diagram of an example of movement of images performed when the viewer has tilted his or her head. In FIG. 13, the line connecting both eyes of the viewer rotates counterclockwise with respect to the horizontal direction as viewed from the viewer. In this case, the entire screen of the display unit 66 appears to the viewer to rotate clockwise. The direction of the vector from the image 51L to the image 51R is not parallel to the direction 7 of the line connecting both eyes of the viewer. Since the direction 5 of eye movement of the viewer for viewing a stereoscopic image is parallel to the direction 7, the viewer has difficulty perceiving a stereoscopic image.

Thus, the image processor 268 of FIG. 11 moves the image 51L downward and the image 51R upward based on the value of the tilt received. Such an operation causes the image 51L to appear to the viewer to move downward to become the image 252L, and the image 51R to appear to the viewer to move upward. (For simplicity, FIG. 13 omits to show the movement of the image 51R.) In this operation, the image processor 268 provides control so that the direction of the vector 9 from the image 252L to the image 51R will be close to the direction 7 of the line connecting both eyes of the viewer. Since the direction of the vector 9 becomes close to the direction 7, the viewer can superimpose the images 252L and 51R, and perceive a stereoscopic image without uncomfortable feeling.

According to the stereoscopic display system of FIG. 9, as described above, even if the viewer tilts his or her head with respect to the screen which displays images for providing a stereoscopic image, the images on the screen are moved to correct the apparent positions of the images, thereby allowing the viewer to successfully perceive a stereoscopic image. Accordingly, the viewer can enjoy a stereoscopic image in a comfortable position.

Referring to FIGS. 9-13, a case has been described in which the positions of the images are moved only in the vertical direction. In such a case, the effect of rotation of the screen as viewed from the viewer is not completely canceled out in a strict sense. However, due to the human visual characteristics, displacement of images in the vertical direction has a more significant effect on the perception of a stereoscopic image than rotation of images, and thus moving the images on the screen in the vertical direction alone facilitates the perception of a stereoscopic image if the tilt of the line connecting both eyes of the viewer is small. Moving images on the screen in the vertical direction requires a smaller amount of memory and a smaller amount of computation, and thus requires a smaller size of hardware than a process of rotating images, thereby allowing the cost of the system to be reduced.

FIG. 14 is an illustrative diagram of apparent movement of the images in the case of FIG. 13. When the viewer tilts his or her head, the images as viewed from the viewer rotate, for example, as shown by the arrows 74. In this case, an object 71L in the left eye image 51L appears to move to the position of the object 72L, and an object 71R in the right eye image 51R appears to move to the position of the object 72R. Moving the positions of the images in the vertical direction on the screen corresponds to moving the objects 72L and 72R, for example, along the arrows 77.

Here, the positions of the images on the screen may further be moved in the horizontal direction. Such movement corresponds to moving the objects 72L and 72R, for example, along the arrows 78. In order to achieve such movement, the image processor 268 of FIG. 11 further moves the objects 72L and 72R to the right and left, respectively, on the screen. In this operation, the image processor 268 provides control so that the images 51L and 51R move by the distances corresponding to the arrows 78 based on the value of the tilt received. Such an operation allows the objects 72L and 72R to be returned to the original positions, that is, the positions of the objects 71L and 71R, thereby further reducing the effect of rotation of the images as viewed from the viewer, and allowing the viewer to perceive a stereoscopic image more naturally.

Although the foregoing description has been provided in which the image processor 268 moves both the images 51L and 51R, the image processor 268 may move only one of the images 51L and 51R.

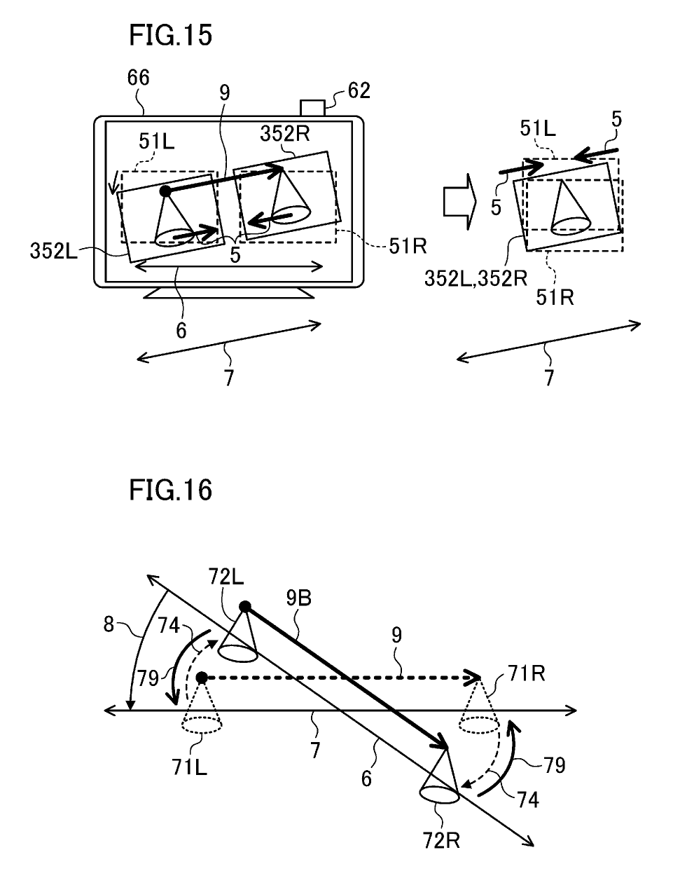

FIG. 15 is an illustrative diagram of another example of movement of images performed when the viewer has tilted his or her head. Although the foregoing description has been provided in which the image processor 268 of FIG. 11 provides translational movement to the images 51L and 51R, the image processor 268 may move the images 51L and 51R by a rotating process.

In such a case, the image processor 268 of FIG. 11 rotates the images 51L and 51R around a point on the screen of the display unit 66 based on the value of the tilt received so as to reduce the effect of the tilt of the line connecting both eyes of the viewer on how the images appear to the viewer. This operation causes the images 51L and 51R as viewed from the viewer to become the images 352L and 352R. In this operation, the image processor 268 provides control so that the direction of the vector 9 from the image 352L to the image 352R will be close to the direction 7 of the line connecting both eyes of the viewer. Specifically, the image processor 268 rotates the images 51L and 51R, for example, by the same angle in the same direction as those of the data of the tilt received. The center of rotation is, for example, the center of the screen. Since the direction of the vector 9 becomes close to the direction 7, the viewer can superimpose the images 352L and 352R, and perceive a stereoscopic image without uncomfortable feeling.

FIG. 16 is an illustrative diagram of apparent movement of the images in the case of FIG. 15. When the viewer tilts his or her head, the images as viewed from the viewer rotate, for example, as shown by the arrows 74. In this case, the object 71L in the left eye image 51L appears to move to the position of the object 72L, and the object 71R in the right eye image 51R appears to move to the position of the object 72R. Rotating the positions of the images on the screen corresponds to moving the objects 72L and 72R, for example, as shown by the arrows 79. Such movement allows the objects 72L and 72R to be returned to the original positions, that is, the positions of the objects 71L and 71R, thereby reducing the effect of rotation of the images as viewed from the viewer, and allowing the viewer to perceive a stereoscopic image more naturally.

As described above referring to FIGS. 15 and 16, even if the viewer tilts his or her head with respect to the screen which displays images for providing a stereoscopic image, the process of rotating images causes the images on the screen to rotate, and thus the apparent positions and angles of the images are corrected accordingly, thereby allowing the viewer to successfully perceive a stereoscopic image. In particular, the angles of the images change depending on the tilt of the head, and thus the tilt of the displayed letters as viewed from the viewer is small, and the readability improves. Accordingly, even in a comfortable position such as lying position, the viewer can enjoy a stereoscopic image.

Although the foregoing description has been provided in which the tilt measurement unit 14 is included in the stereoscopic glasses 210, all that is required of the tilt measurement unit 14 is to move with the head (the region above the neck) of the viewer. For example, the tilt measurement unit 14 as well as a transmitter which transmits the determined value thereof to the stereoscopic display unit 260 may be fixed on a device usually worn over the head such as a headphone set, a headgear, and a helmet. The viewer wears one of these devices over the head, and the tilt measurement unit 14 determines the tilt of the head of the viewer, thereby determining the tilt 8 of the line 7 connecting both eyes of the viewer. The transmitter transmits the value of the tilt determined by the tilt measurement unit 14 to the stereoscopic display unit 260.

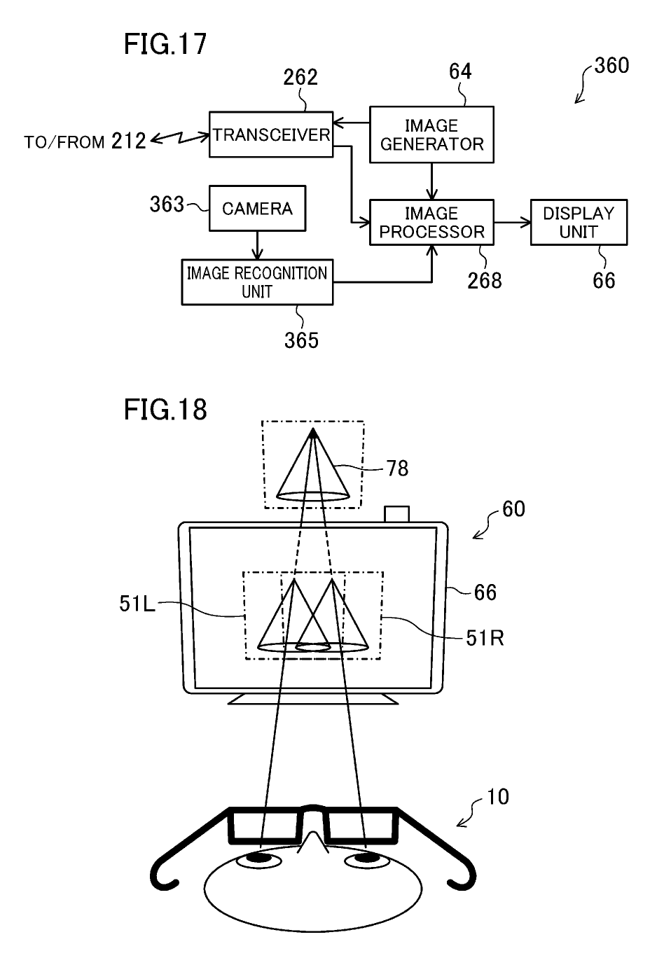

FIG. 17 is a block diagram illustrating a configuration of a variation of the stereoscopic display unit 260 of FIG. 11. The stereoscopic display unit 360 of FIG. 17 differs from the stereoscopic display unit 260 of FIG. 11 in further including a camera 363 and an image recognition unit 365 as a tilt measurement unit.

The camera 363, which images the face and/or the head of the viewer, and the image recognition unit 365, which performs image recognition of the face or the eyes of the viewer as imaged by the camera 363, thereby determines the tilt of the line connecting both eyes of the viewer, may be placed apart from the stereoscopic glasses 210, and used as a tilt measurement unit. In such a case, the pair of stereoscopic glasses 210 does not need to include the tilt measurement unit 14. The image processor 268 of FIG. 17 is provided with a value determined by the image recognition unit 365. The image processor 268 performs a process such as moving images based on the determined value as described above referring to FIG. 11.

For example, this process may be implemented such that a marker is placed on the head of the viewer, and the image recognition unit 365 performs image recognition of the position and/or the angle of the marker placed on the head of the viewer as imaged by the camera 363, and then determines the tilt of the line connecting both eyes of the viewer based on the recognition result. Examples of the marker include a light emitting element such as a light emitting diode (LED), or a predetermined mark.

The image recognition unit 365 may use face recognition technology recently used in digital cameras, etc. The image recognition unit 365 has a face recognition function, which recognizes the positions of components of the face such as both eyes and/or both ears, the angle of the face or the head, etc., of the viewer as imaged by the camera 363, and then determines the tilt of the line connecting both eyes of the viewer based on the recognition result obtained by this technology. As described above, if the image recognition unit 365 is used to recognize the eyes etc. of the viewer, no markers are required on the head of the viewer.

Use of such a tilt measurement unit placed apart from the pair of stereoscopic glasses 210 allows the stereoscopic display unit 360 of FIG. 17 to be used without eyewear even when a stereoscopic image is displayed using a lenticular method etc.

The stereoscopic display unit 60 of FIG. 3 may further include, similarly to the stereoscopic display unit 360 of FIG. 17, a camera 363 and an image recognition unit 365 as a tilt measurement unit. The receiver 12 receives the value determined by the image recognition unit 365 from, for example, the transmitter 62 by means of infrared light, a radio wave, etc. In such a case, the pair of stereoscopic glasses 10 of FIG. 2 does not need to include the tilt measurement unit 14.

FIG. 18 is an illustrative diagram of a case where the left eye image 51L and the right eye image 51R are displayed on the screen of the display unit 66, partially superimposed over each other. Although the foregoing description has been provided in which the left eye image (51L etc.) and the right eye image (51R etc.) do not overlap for purposes of better understanding, the both images may overlap as shown in FIG. 18. In practice, the distance between the left eye image and the right eye image is not very great in most cases, and thus the both images are partially overlapped on the screen as shown in FIG. 18. The viewer feels, for example, as if the stereoscopic image 78 were at the position shown in FIG. 18.

Each function block described herein can typically be implemented in hardware. For example, each function block can be formed on a semiconductor substrate as a part of an integrated circuit (IC). As used herein, the term IC includes large-scale integrated circuit (LSI), application-specific integrated circuit (ASIC), gate array, field programmable gate array (FPGA), etc. Alternatively, a part or all of each function block can be implemented in software. For example, such a function block can be implemented by a processor and a software program executed by the processor. In other words, each function block described herein may be implemented in hardware, software, or any combination of hardware and software.

As described above, this embodiment reduces strain of the viewer in viewing a stereoscopic image, and thus the present invention is useful for stereoscopic display systems, stereoscopic glasses, etc.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A stereoscopic display system, comprising:
an image display unit configured to display a left eye image and a right eye image for stereoscopic viewing;
a pair of stereoscopic glasses configured to be worn by a viewer for stereoscopically viewing the left eye image and the right eye image displayed on the image display unit; and
a tilt measurement unit configured to determine a tilt of a line connecting both eyes of the viewer with respect to a reference direction,
wherein
the pair of stereoscopic glasses includes
an optical axis change unit configured to transmit light which should enter one of the eyes of the viewer, and to change at least one of directions of an optical axis on an incident side and of an optical axis on a transmission side of the optical axis change unit, and
a control unit configured to change at least one of the directions of the optical axis on the incident side and of the optical axis on the transmission side of the optical axis change unit based on the tilt determined by the tilt measurement unit so as to reduce an effect of the tilt of the line on how the images appear to the viewer.

2. The stereoscopic display system of claim 1, wherein
the pair of stereoscopic glasses further includes the tilt measurement unit, and
the tilt measurement unit determines the tilt of the line by determining a tilt of the pair of stereoscopic glasses.

3. A stereoscopic display system, comprising:
an image display unit; and
a tilt measurement unit configured to determine a tilt of a line connecting both eyes of the viewer with respect to a reference direction,
wherein
the image display unit includes
an image generator configured to generate a left eye image and a right eye image for stereoscopic viewing,
an image processor configured to perform a process of moving at least one of the left eye image or the right eye image based on the tilt determined by the tilt measurement unit so as to reduce an effect of the tilt of the line on how the images appear to the viewer, and
a display unit configured to display the left eye image and the right eye image at least one of which is processed by the image processor.

4. The stereoscopic display system of claim 3, wherein
the image processor provides translational movement to at least one of the left eye image or the right eye image.

5. The stereoscopic display system of claim 3, wherein
the image processor rotates the left eye image and the right eye image around a predetermined point.

6. The stereoscopic display system of claim 3, further comprising:
a pair of stereoscopic glasses configured to be worn by a viewer for stereoscopically viewing the left eye image and the right eye image displayed on the image display unit,
wherein
the pair of stereoscopic glasses includes
a transmitter, and
the tilt measurement unit,
the image display unit further includes a receiver,
the tilt measurement unit determines the tilt of the line by determining a tilt of the pair of stereoscopic glasses,
the transmitter transmits data of the tilt determined by the tilt measurement unit,
the receiver receives the data of the tilt transmitted from the transmitter, and
the image processor performs the process based on the data of the tilt received.

7. The stereoscopic display system of claim 3, further comprising:
a transmitter,
wherein
the image display unit further includes a receiver,
the tilt measurement unit is worn over the head of the viewer, and determines the tilt of the line by determining a tilt of the head of the viewer,
the transmitter transmits data of the tilt determined by the tilt measurement unit,
the receiver receives the data of the tilt transmitted from the transmitter, and
the image processor performs the process based on the data of the tilt received.

8. The stereoscopic display system of claim 3, wherein
the tilt measurement unit includes
a camera configured to image the viewer, and
an image recognition unit configured to recognize a position or an angle of an identification marker placed on the head of the viewer as imaged by the camera, and to determine the tilt of the line based on a recognition result.

9. The stereoscopic display system of claim 3, wherein
the tilt measurement unit includes
a camera configured to image the viewer, and
an image recognition unit having a face recognition function which recognizes positions of both eyes, or an angle of the head, of the viewer as imaged by the camera, and configured to determine the tilt of the line based on a recognition result.

10. A pair of stereoscopic glasses worn by a viewer for stereoscopically viewing images displayed on an image display unit, comprising:
a tilt measurement unit configured to determine a tilt of the pair of stereoscopic glasses with respect to a reference direction;
an optical axis change unit configured to transmit light which should enter one of the eyes of the viewer, and to change at least one of directions of an optical axis on an incident side and of an optical axis on a transmission side of the optical axis change unit; and
a control unit configured to change at least one of the directions of the optical axis on the incident side and of the optical axis on the transmission side of the optical axis change unit based on the tilt determined by the tilt measurement unit so as to reduce an effect of a tilt of a line connecting both eyes of the viewer on how the images appear to the viewer.
